(19) United States
(12) Patent Application Publication
(10) Pub. No.: US 2010/0250042 A1
(43) Pub. Date: Sep. 30, 2010

(54) VEHICLE AND METHOD OF CONTROLLING THE VEHICLE

(75) Inventor: Sumikazu Shamoto, Nagoya-shi (JP)

Correspondence Address: KENYON & KENYON LLP, 1500 K STREET N.W., SUITE 700, WASHINGTON, DC, 20005, US

(73) Assignee: TOYOTA JIDOSHA KABUSHIKI KAISHA, Toyota-shi (JP)

(21) Appl. No.: 12/743,923

(22) PCT Filed: Nov. 13, 2008
(86) PCT No.: PCT/IB08/03051

§ 371 Date: May 20, 2010

(30) Foreign Application Priority Data
Nov. 21, 2007 (JP) 2007-301286

(51) Int. Cl. B60L 11/00

(52) U.S. Cl. 701/22

(57) ABSTRACT

A vehicle that includes an electric power generating section, an electric motor, a charge storage section that exchanges electric power with the electric power generating section and the electric motor is provided. In the vehicle, a requested drive force setting section sets a requested drive force to move the vehicle, a central value setting section sets a central value of a state of charge in a range of state-of-charge control used to control the state of charge of the charge storage section, based on an accelerator operation, and a control section controls the state of charge of the charge storage section based on the set central value, and further controls the electric power generating section and the electric motor so that the vehicle moves by the set requested drive force.

### BACKGROUND OF THE INVENTION

1. Field of the Invention

The present invention relates to a vehicle and a method of controlling the vehicle.

2. Description of the Related Art

Japanese Patent Application Publication No. 2002-238106 (JP-A-2002-238106) describes a vehicle that includes an engine, a torque distributor connected to the engine and the wheels of the vehicle, a generator connected to the torque distributor, a motor connected to the vehicle wheels, and a secondary battery that exchanges electric power with the generator and the motor. In the described vehicle, the secondary battery is charged or discharged so that the SOC (State of Charge) of the secondary battery is maintained around a predetermined target SOC.

Generally, this type of vehicle is equipped with a small secondary battery, so it is important to control the SOC of the secondary battery in a more appropriate manner. In particular, it is required to control the secondary battery by setting an appropriate value as the target SOC.

### SUMMARY OF THE INVENTION

The present invention provides a vehicle that controls a charge storage device in a more appropriate manner, and a method of controlling the vehicle.

A vehicle according to one aspect of the present invention includes an electric power generating means for generating electric power when supplied with fuel; an electric motor that outputs motive power; a charge storage means for exchanging electric power with the electric power generating means and the electric motor; a requested drive force setting means for setting a requested drive force to move the vehicle; a control central value setting means for setting a central value of a state-of-charge in a range of the state-of-charge control used for controlling the state-of-charge of the charge storage means, based on an accelerator operation; and a control means for controlling the state of charge of the charge storage means based on the set central value, and for further controlling the electric power generating means and the electric motor so that the vehicle moves by the set requested drive force.

Accordingly, the central value can be set in a more appropriate manner, and the state of charge of the charge storage means may be controlled in a more appropriate manner. Also, it is understood that the vehicle can move by a drive force based on the requested drive force.

The control central value setting means may set the central value based on a brake operation, in addition to the accelerator operation. In this way, the central value may be set in a more appropriate manner.

The control central value setting means may set the central value based on an accelerator change rate, which is an amount of change in accelerator operation per unit time in a predetermined period of time, and a brake change rate, which is an amount of change in brake operation per unit time in the predetermined period of time. In this case, the accelerator change rate may be the amount of change in accelerator operation per unit time when the amount of accelerator operation increases in the predetermined period of time, and the brake change rate is the amount of change in brake operation per unit time when the amount of brake operation increases in the predetermined period of time.

In addition, the control central value setting means may increase the central value as the accelerator change rate increases relative to the brake change rate. In this case, in the vehicle that accelerates by outputting motive power from the electric motor by using electric power generated by the electric power generating means and electric power discharged from the charge storage means, when the driver requests fast acceleration or slow deceleration with high frequency, a large central value is set so that the amount of electric power that can be discharged from the charge storage means increases, thereby making it possible to meet the driver's acceleration request in a more satisfactory manner. Likewise, if the driver requests slow acceleration with high frequency, a small central value is set so that, during braking, the electric motor is driven to perform regenerative braking to increase the amount of electric power for recharging the charge storage means, thereby improving energy efficiency.

Also, the control central value setting means may set the central value based on an accelerator operation time, which is a duration of time over which the accelerator is operated within a predetermined period of time, and a brake operation time, which is a duration of time over which the brake is operated within the predetermined period of time. In this case, the control central value setting means may increase the central value as the accelerator operation time increases relative to the brake operation time. Accordingly, when the driver performs an accelerator operation for a relatively long period of time in comparison to a brake operation, upon acceleration following a driver's acceleration request, motive power is output from the electric motor by using electric power generated by the electric power generating means and electric power discharged from the charge storage means, thereby making it possible to meet the driver's acceleration request in a more appropriate manner. Also, when the driver performs a brake operation for a relatively long period of time, during braking following a driver's deceleration request, the electric motor may be driven to perform regenerative braking to increase the amount of electric power for recharging the charge storage means, thereby improving energy efficiency. Also, in the vehicle that accelerates by outputting motive power from the electric motor by using electric power generated by the electric power generating means and electric power discharged from the charge storage means, when the driver performs an accelerator operation for a relatively long time in comparison to a brake operation, a relatively large central value is set so that the amount of electric power that can be discharged from the charge storage means increases, thereby making it possible to meet the driver's acceleration request in a more satisfactory manner. Also, if the driver operates the brake for a relatively long time in comparison to an accelerator operation, a relatively small central value is set so that, during braking, the electric motor may be driven to perform regenerative braking to generate a larger amount of electric power for recharging the storage means, thereby improving energy efficiency.

The control central value setting means may compute a vehicle weight based on a motive drive force that is output to move the vehicle and an acceleration of the vehicle, and sets the central value based on the accelerator operation, the computed vehicle weight, and the vehicle speed. In this way, the central value may be set in a more appropriate manner.

In addition, the requested drive force setting means may set the requested drive force based on the accelerator operation and a brake operation; and the control central value setting means may set the central value based on the requested drive force. Also, the requested drive force setting means may set the requested drive force based on the accelerator operation and the brake operation; the control means may set a target drive state of the electric motor based on the set requested drive force and also controls the electric motor so that the electric motor is driven in the set target drive state; and the control central value setting means may set the central value based on the drive state of the electric motor.

Further, the electric power generating means includes an internal combustion engine, and a generator that generates electric power by using at least a part of power from the internal combustion engine. In this case, the electric power generating means includes triaxial power transfer means connected to a drive shaft, which is coupled to an axle; an output shaft of the internal combustion engine; and a rotating shaft of the generator; for transferring power, based on power input from two of the three shafts, to the remaining shaft, and for transferring power based on power input from one of the three shafts, to the remaining two shafts, and the electric motor input power from or outputs power to the drive shaft.

According to another aspect of the present invention, a method of controlling a vehicle is provided. The vehicle includes an electric power generating section that generates electric power when supplied with fuel, an electric motor that outputs motive power, and a charge storage section that exchanges electric power with the electric power generating section and the electric motor. In the control method, a central value of a state-of charge in a range of state-of-charge control used to control a state of charge of the charge storage section is set based on an accelerator operation. A state of charge of the charge storage section is controlled based on the set central value, and also the electric power generating section and the electric motor are controlled so that the vehicle moves by a requested drive force to move the vehicle.

According to the above-described aspect, the central value can be set in a more appropriate manner, and the state of charge of the charge storage section can be controlled in a more appropriate manner. Also, it is understood that the vehicle can move by a drive force based on the requested drive force.

### BRIEF DESCRIPTION OF THE DRAWING

The foregoing and further features and advantages of the invention will become apparent from the following description of example embodiments with reference to the accompanying drawings, wherein like numerals are used to represent like elements and wherein:

FIG. 1 is a block diagram showing an overview of the configuration of a hybrid automobile according to an embodiment of the present invention;

FIG. 2 is a flowchart showing an example of a drive control routine executed by a hybrid electronic control unit according to the embodiment;

FIG. 3 is an explanatory diagram showing an example of a requested torque setting map;

FIG. 4 is a flowchart showing an example of a control central value setting process;

FIG. 5 is an explanatory diagram showing an example of a requested charge/discharge power setting map;

FIG. 6 is an explanatory diagram showing an example of an engine operation line and how a target rotational speed Ne* and a target torque Te* are set;

FIG. 7 is an explanatory diagram showing an example of an alignment chart showing the dynamic relationship between the rotational speed and the torque for rotational elements of a power distribution/integration mechanism when the vehicle is moving in a state with power output from the engine;

FIG. 8 is an explanatory diagram showing an example of a control central value setting map;

FIG. 9 is a flowchart showing an example of a control central value setting process according to a modification;

FIG. 10 is an explanatory diagram showing an example of a control central value setting map according to a modification;

FIG. 11 is a flowchart showing an example of a control central value setting process according to a modification;

FIG. 12 is an explanatory diagram showing an example of a control central value setting map according to a modification;

FIG. 13 is a block diagram showing an overview of the configuration of a hybrid automobile according to a modification;

FIG. 14 is a block diagram showing an overview of the configuration of a hybrid automobile according to a modification;

FIG. 15 is a block diagram showing an overview of the configuration of a hybrid automobile according to a modification; and

FIG. 16 is a block diagram showing an overview of the configuration of a fuel cell powered automobile according to a modification.

### DETAILED DESCRIPTION OF EMBODIMENTS

Hereinafter, embodiments of the present invention will be described with reference to the drawings.

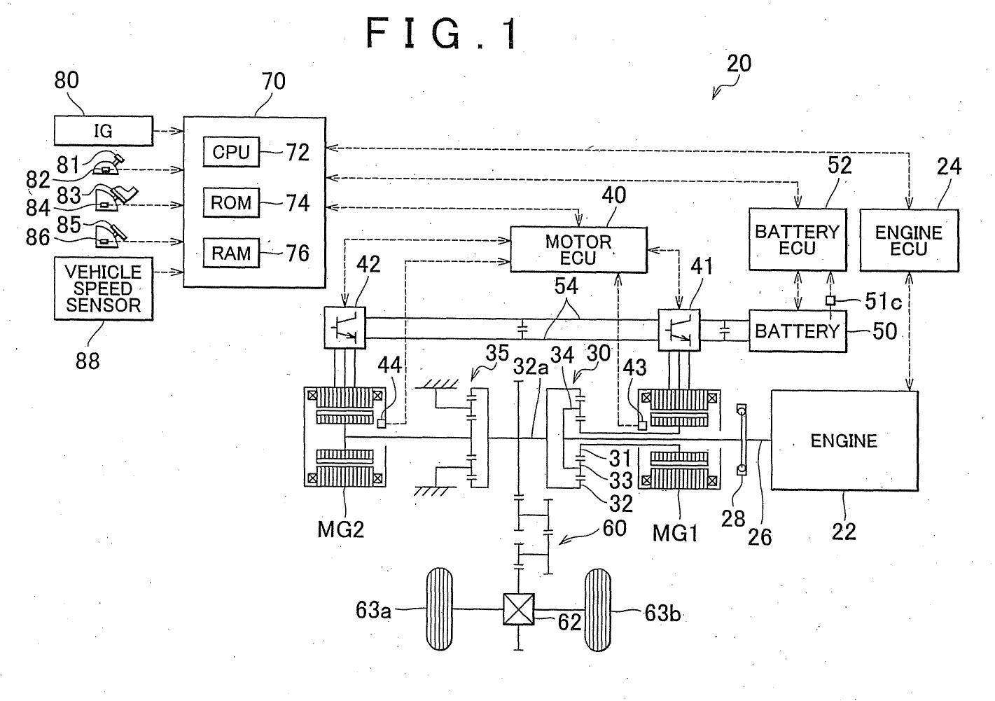

FIG. 1 is a block diagram showing an overview of the configuration of a hybrid automobile 20 according to an embodiment of the present invention. As shown in the drawing, the hybrid automobile 20 according to the embodiment includes an engine 22, a triaxial power distribution/integration mechanism 30 connected to a crankshaft 26, which serves as an output shaft of the engine 22, via a damper 28, a motor MG1 that is connected to the power distribution/integration mechanism 30 and capable of generating electric power, a reduction gear 35 attached to a ring gear shaft 32a, which serves as a drive shaft, connected to the power distribution/integration mechanism 30, a motor MG2 connected to the reduction gear 35, and a hybrid electronic control unit 70 that controls the entire vehicle.

The engine 22 is an internal combustion engine that outputs power using a hydrocarbon fuel, such as gasoline or diesel fuel. An engine electronic control unit (hereinafter, referred to as engine ECU) 24 executes control operations for the engine 22 such as fuel injection control, ignition control, and intake air flow regulation control. Signals from various sensors that detect the operating state of the engine 22 are input to the engine ECU 24, for example, a signal that indicates a crank position from a crank position sensor (not shown) that detect the crank angle of the crankshaft 26 of the engine 22. The engine ECU 24 communicates with the hybrid electronic control unit 70, and controls the operation of the engine 22 by a control signal from the hybrid electronic control unit 70 while outputting data related to the operating state of the engine 22 to the hybrid electronic control unit 70 as required. It should be noted that the engine ECU 24 also computes the rotational speed of the crankshaft 26, that is, the engine speed Ne of the engine 22 based on the crank position.

The power distribution/integration mechanism 30 includes a sun gear 31, a ring gear 32 arranged concentrically with the sun gear 31, a plurality of pinion gears 33 that mesh with the sun gear 31 and the ring gear 32, and a carrier 34 that holds the plurality of pinion gears 33 in a manner that allows the pinion gears 33 to both revolve and rotate on their own axes. The power distribution/integration mechanism 30 is a planetary gear mechanism that provides differential action with the sun gear 31, the ring gear 32, and the carrier 34 as rotational elements. In the power distribution/integration mechanism 30, the crankshaft 26 is coupled to the carrier 34, the motor MG1 is coupled to the sun gear 31, and the reduction gear 35 is coupled to the ring gear 32 via the ring gear shaft 32a. When the motor MG1 operates as a generator, the power of the engine 22 input from the carrier 34 is transferred to the sun gear 31 and the ring gear 32 in accordance with their gear ratio. When the motor MG1 operates as an electric motor, the power of the engine 22 input from the carrier 34 and the power of the motor MG1 input from the sun gear 31 are integrated and output to the ring gear 32. The power output to the ring gear 32 is output from the ring gear 32a via a gear mechanism 60 and a differential gear 62, eventually to drive wheels 63a and 63b of the vehicle.

Both of the motors MG1 and MG2 are known synchronous generator/motors, which may be driven as both generators and electric motors and exchange electric power with a battery 50 via inverters 41 and 42. A power line 54 that connects the inverters 41 and 42 with the battery 50 includes a positive bus line and a negative bus line shared by the inverters 41 and 42, thus allowing electric power generated by one of the motors MG1 and MG2 to be consumed by the other. Accordingly, the battery 50 may be charged with electric power generated by either of the motors MG1 and MG2. Conversely, the motor MG1 and MG2 may drawn on the electric power stored in the battery 50. The battery 50 is neither charged nor discharged provided that the electric power balance is maintained between the motors MG1 and MG2. The operations of both the motors MG1 and MG2 are controlled by a motor electronic control unit (hereinafter, referred to as motor ECU) 40. The motor ECU 40 receives signals required for controlling the motors MG1 and MG2, such as signals from rotational position sensors 43 and 44, which detect the rotational positions of rotors in the motors MG1 and MG2, and signals that indicate the phase currents applied to the motors MG1 and MG2 as detected by current sensors (not shown). The motor ECU 40 outputs switching control signals to the inverters 41 and 42. The motor ECU 40 communicates with the hybrid electronic control unit 70. The motor ECU 40 controls the motors MG1 and MG2 in accordance with control signals from the hybrid electronic control unit 70 and also outputs data related to the operating states of the motors MG1 and MG2 to the hybrid electronic control unit 70 as required. It should be noted that the motor. ECU 40 also computes rotational speeds Nm1 and Nm2 of the motors MG1 and MG2 based on signals from the rotational position sensors 43 and 44.

The battery 50 may be a lithium ion battery that is controlled by a battery electronic control unit (hereinafter, referred to as battery ECU) 52. The battery ECU 52 receives signals required to control the battery 50, such as a signal that indicates the inter-terminal voltage from a voltage sensor (not shown) disposed between terminals of the battery 50, a signal that indicates the charge/discharge electric current from a current sensor (not shown) attached to the power line 54 connected to an output terminal of the battery 50, and a signal that indicates the battery temperature Tb from a temperature sensor 51 attached to the battery 50. The battery ECU 52 outputs data related to the state of the battery 50 to the hybrid electronic control unit 70 via communication. Also, the battery ECU 52 computes a state of charge SOC based on an integrated value of charge/discharge currents detected by the current sensor for controlling the battery 50, or computes input and output limits Win and Wout, which represent the maximum allowed electric power that may be charged into and discharged from the battery 50 respectively, based on the computed state of charge SOC and the battery temperature Tb. It should be noted that the input and output limits Win and Wout for the battery 50 may be set by setting basic values of the input and output limits Win and Wout based on the battery temperature Tb, setting an output limit correction factor and an input limit correction factor based on the state of charge SOC of the battery 50, and multiplying the basic values of the input and output limits Win and Wout by the correction factors.

The hybrid electronic control unit 70 is a microprocessor configured mainly by a CPU 72, and may further include a ROM 74 that stores processing programs, a RAM 76 that temporarily stores data, input and output ports (not shown), and a communication port (not shown). The hybrid electronic control unit 70 receives various inputs via the input port, including an ignition signal from an ignition switch 80, a shift position SP from a shift position sensor 82 that detects the operational position of a shift lever 81, an accelerator opening Acc from an accelerator pedal position sensor 84 that detects the amount of depression of an accelerator pedal 83, a brake pedal position BP from a brake pedal position sensor 86 that detects the amount of depression of a brake pedal 85, and a vehicle speed V from a vehicle speed sensor 88. As described above, the hybrid electronic control unit 70 is connected to the engine ECU 24, the motor ECU 40, and the battery ECU 52 via the communication port to exchange various control signals and data with the engine ECU 24, the motor ECU 40, and the battery ECU 52.

In the hybrid automobile 20 according to this embodiment configured as described above, the requested torque to be output to the ring gear shaft 32a, which serves as the drive shaft, is calculated based on the accelerator opening Acc corresponding to the amount of depression of the accelerator pedal 83 by the driver, and the vehicle speed V, and the operations of the engine 22 and the motors MG1 and MG2 are controlled in such a way that requested power corresponding to this requested torque is output to the ring gear shaft 32a. Examples of the operation control modes for the engine 22 and the motors MG1 and MG2 include a torque conversion operation mode, a charge/discharge operation mode, and a motor operation mode. The torque conversion operation mode controls the operation of the engine 22 to output the requested power. The torque conversion operation mode also controls the operations of the motors MG1 and MG2 so that all of the power output from the engine 22 is subjected to torque conversion by the power distribution/integration mechanism 30 and the motors MG1 and MG2 before being output to the ring gear shaft 32a. The charge/discharge operation mode controls the operation of the engine 22 to output power equal to the sum of the requested power and the electric power necessary for charging/discharging of the battery 50. The charge/discharge operation mode also controls the operations of the motors MG1 and MG2 so that all or part of the power output from the engine 22 with charging/discharging of the battery 50 is subjected to torque conversion by the power distribution/integration mechanism 30 and the motors MG1 and MG2 and requested power is output to the ring gear shaft 32a. The motor operation mode controls the operations of motors MG1 and MG2 to output the requested power to the ring gear shaft 32a while the engine 22 is stopped. It should be noted that the torque conversion operation mode and the charge/discharge operation mode are both modes that control the engine 22 and the motors MG1 and MG2 to output the requested power to the ring gear shaft 32a while the engine 22 is operating, and there are no practical differences between the two modes in terms of control. Thus, hereinafter, the two modes are collectively referred to as engine operation mode.

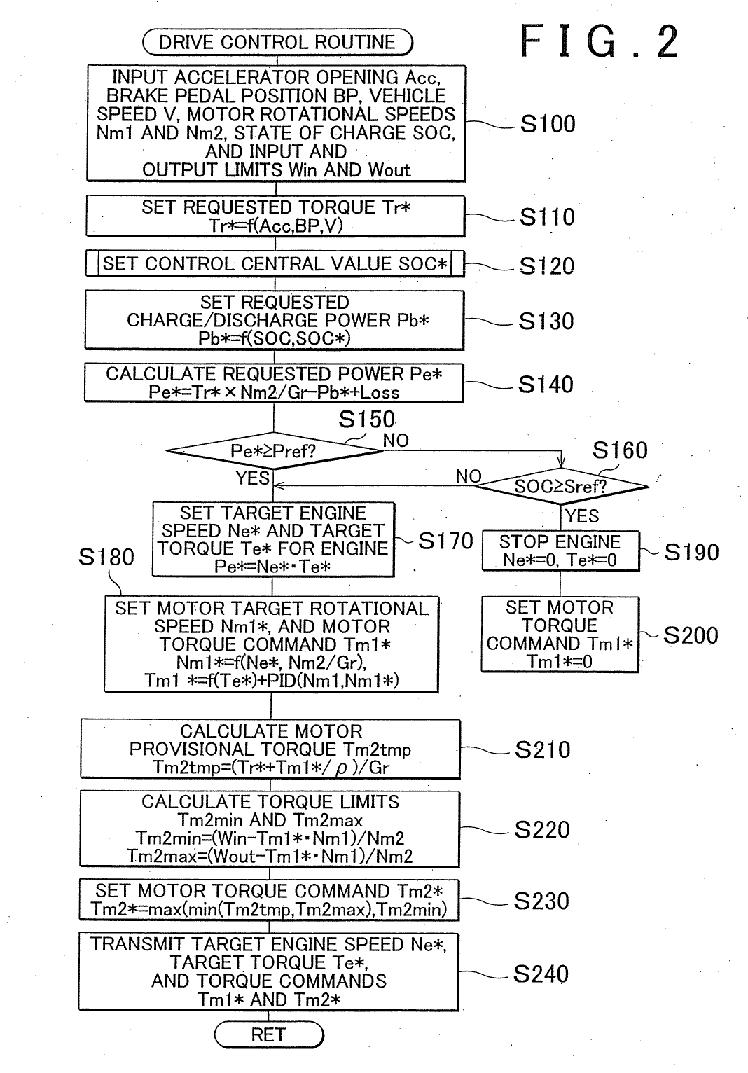

Next, operation of the hybrid automobile 20 according to this embodiment configured as described above will be described. FIG. 2 is a flowchart that shows a drive control routine executed by the hybrid electronic control unit 70. The routine is executed at predetermined intervals (for example, every several msec).

When the drive control routine is executed, the CPU 72 of the hybrid electronic control unit 70 first executes a process of inputting data required for control, such as the accelerator opening Acc from the accelerator pedal position sensor 84, the brake pedal position BP from the brake pedal position sensor 86, the vehicle speed V from the vehicle speed sensor 88, the rotational speeds Nm1 and Nm2 of the motors MG1 and MG2, the state of charge SOC of the battery 50, and the input and output limits Win and Wout for the battery 50 (step S100). The rotational speeds Nm1 and Nm2 of the motors MG1 and MG2, respectively, are computed based on the rotational positions of the rotors of motors MG1 and MG2 as detected by the rotational position sensors 43 and 44 and are input to the hybrid electronic control unit 70 from the motor ECU 40 via communication. The state of charge SOC of the battery 50, is computed based on an integrated value of charge/discharge currents detected by the current sensor (not shown) and is input to the hybrid electronic control unit 70 from the battery ECU 52 via communication. In addition, the battery ECU 52 also inputs the input and output limits Win and Wout for the battery 50 which are set based on the battery temperature Tb of the battery 50 and the state of charge SOC of the battery 50, to the hybrid electronic control unit 70 via communication.

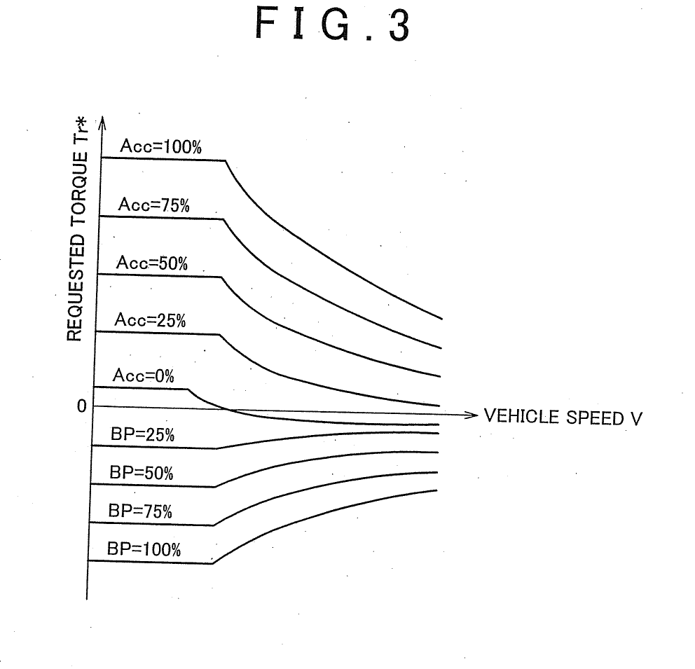

Once the CPU 72 has received the required data, it sets the requested torque Tr* that is to be output to the ring gear shaft 32a based on the detected accelerator opening Acc, brake pedal position BP, and vehicle speed V (step S110). In this embodiment, the requested torque Tr* is set as follows. The relationship among the accelerator opening Acc, the brake pedal position BP, the vehicle speed V, and the requested torque Tr* is determined in advance and stored as a requested torque setting map in the ROM 74, and when the accelerator opening Acc, the brake pedal position BP, and the vehicle speed V are given, the corresponding requested torque Tr* is derived from the stored map. An example of the requested torque setting map is shown in FIG. 3.

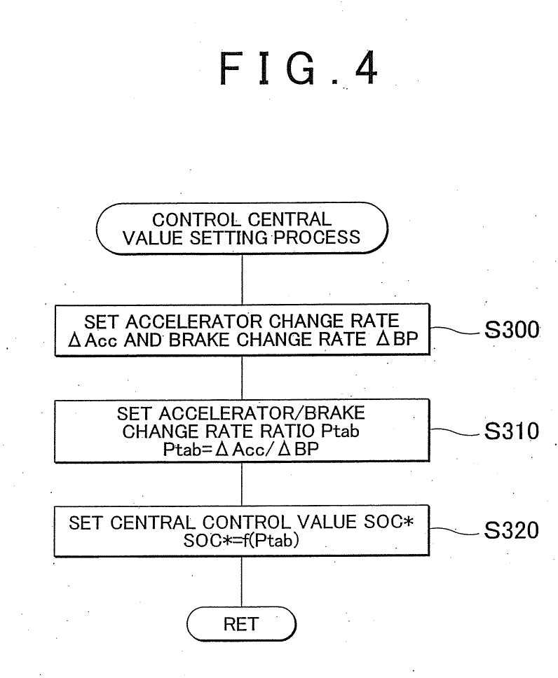

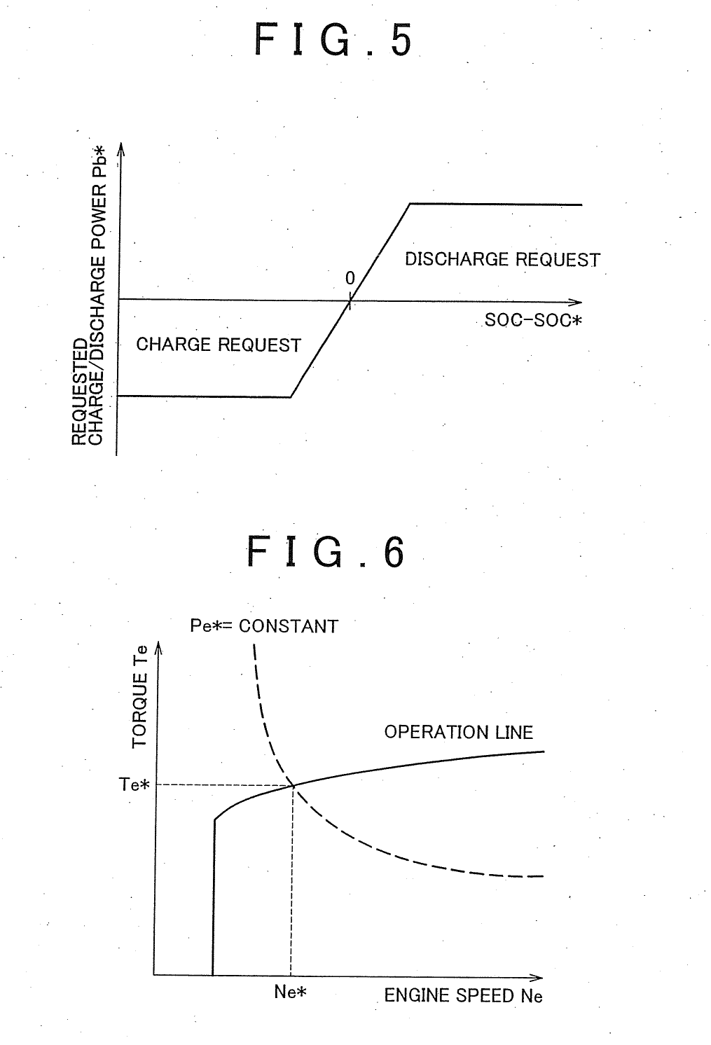

Subsequently, a control central value SOC*, which is the central value of the state of charge in the range of a state-of-charge control (“state-of-charge control range”) for controlling the state of charge of the battery 50, is set by a control central value setting process illustrated in FIG. 4 (step S120), and based on the set control central value SOC*, a requested charge/discharge power Pb*, which is the electric power to be charged into or discharged from the batter 50, is set (step S130). The control central value value setting process shown in FIG. 4 will be described later. The upper and lower limit values Shi and Slow of the state-of-charge control range are determined based on the characteristics of the battery 50 or the like. A value of, for example, 80%, 85%, 90%, or the like may be used as the upper limit value Shi, and a value of, for example, 35%, 40%, 45%, or the like may be used as the lower limit value Slow. In the embodiment, the relationship between the requested charge/discharge power Pb* and a value obtained by subtracting the control central value SOC* from the state of charge SOC (SOC−SOC*) is determined in advance and stored as a requested charge/discharge power setting map in the ROM 74, and when the value (SOC−SOC*) is given, the requested charge/discharge power Pb* for the battery 50 is set by deriving the corresponding requested charge/discharge power Pb* from the stored map. An example of the requested charge/discharge power setting map is shown in FIG. 5. As shown in the drawing, the requested charge/discharge power Pb* is set to a positive (discharge side) value when the value (SOC−SOC*) is positive, that is, when the state of charge SOC is larger than the control central value SOC*, and the requested charge/discharge power Pb* is set to a negative (charge side) value when the value (SOC−SOC*) is negative, that is, when the state of charge SOC is smaller than the control central value SOC*.

Then, requested power Pe* for the vehicle is calculated by subtracting the requested charge/discharge power Pb* for the battery 50 from the product of the requested torque Tr* and the rotational speed Nr of the ring gear shaft 32a, and then adding a loss Loss to the resulting value (step S140). The rotational speed Nr of the ring gear shaft 32a may then be determined by multiplying the vehicle speed V by a conversion factor k (Nr=k·r), or by dividing the rotational speed Nm2 of the motor MG2 by a gear ratio Gr of the reduction gear 35 (Nr=Nm2/Gr).

Next, the requested power Pe* is compared with a first power threshold Pref (step S150), and if the requested power Pe* is below the first power threshold Pref, the state of charge SOC of the battery 50 is compared against a second power threshold Sref (step S160). A value near the lower limit value of a power range in which the engine 22 operates with relatively high efficiency may be set as the first power threshold Pref. Also, the threshold Sref may be set to a value that is larger than the state of charge SOC equivalent to the amount of electric power necessary for the next starting of the engine 22. In this embodiment, in order to control or maintain the state of charge SOC of the battery 50 within the state-of-charge control range, a value larger than the lower limit value Slow of the state-of-charge control range is used. The process of steps S150 and S160 is a process of selecting between the engine operation mode and the motor operation mode described above. In this embodiment, the engine operation mode is selected if the requested power Pe* is equal to or above the first power threshold Pref, or if the requested power Pe* is below the first power threshold Pref and the state of charge SOC of the battery 50 is below the second power threshold Sref, and the motor operation mode is selected if the requested power Pe* is below the threshold Pref and the state of charge SOC of the battery 50 is equal to or above the threshold Sref.

If the requested power Pe* is equal to or exceeds the threshold Pref, or if the requested power Pe* is below the threshold Pref and the state of charge SOC is below the threshold Sref, the engine operation mode is selected, and a target rotational speed Ne* and a target torque Te* that define an operation point at which the engine 22 should be operated are set based on the requested power Pe* (step S170). The target rotational speed Ne* and a target torque Te* are set based on an operation line for efficiently operating the engine 22, and the requested power Pe*. FIG. 6 shows an example of the operation line of the engine 22 and how the target rotational speed Ne* and the target torque Te* are set. As shown in the drawing, the target rotational speed Ne* and the target torque Te* are given as an intersection of the operation line and a curve of constant requested power Pe* (=Ne*×Te*).

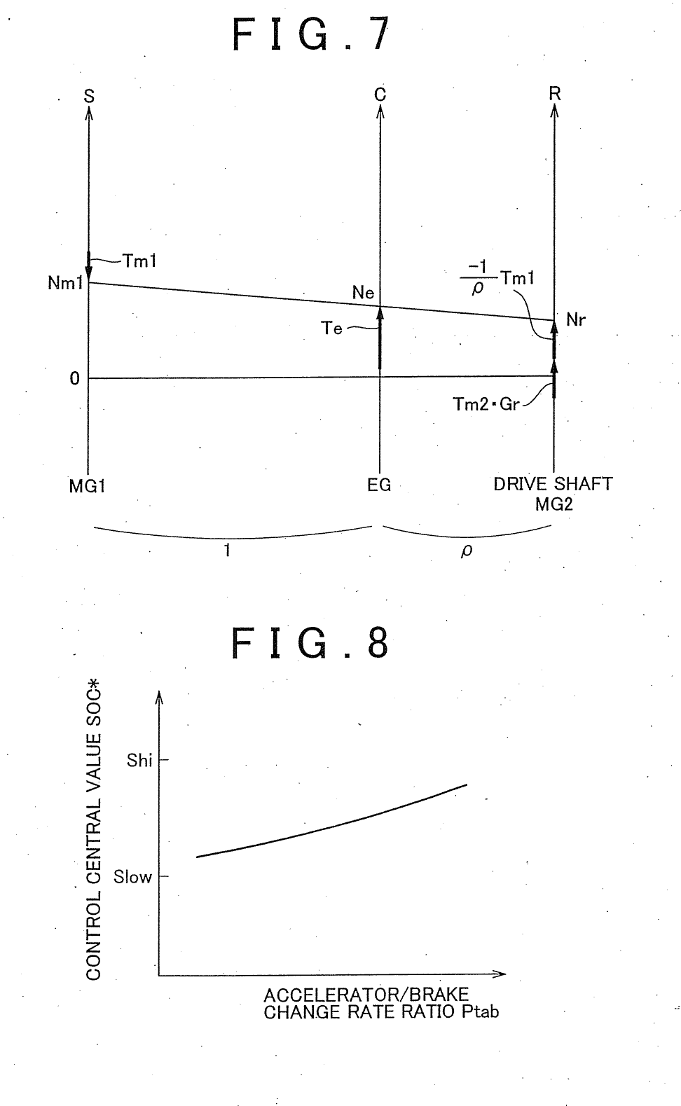

Next, a target rotational speed Nm1* for the motor MG1 is calculated using Equation (1) below from the target rotational speed Ne* for the engine 22, the rotational speed Nm2 of the motor MG2, a gear ratio ρ of the power distribution/integration mechanism 30, and the gear ratio Gr of the reduction gear 35, and also, a torque command Tm1* as a torque to be output from the motor MG1 is calculated using Equation (2) below based on the calculated target rotational speed Nm1*, the input rotational speed Nm1 of the motor MG1, and the target torque Te* for the engine 22, and the gear ratio ρ of the power distribution/integration mechanism 30 (step S180). Equation (1) is a dynamic relational expression with respect to the rotational elements of the power distribution/integration mechanism 30. FIG. 7 shows an example of an alignment chart showing the dynamic relationship between the rotational speed and torque for the rotational elements of the power distribution/integration mechanism 30 when the vehicle moves by outputting the power from the engine 22. In the drawing, the S axis on the left represents the rotational speed of the sun gear 31 (i.e., the rotational speed Nm1 of the motor MG1), the C axis represents the rotational speed of the carrier 34 (i.e., the rotational speed Ne of the engine 22), and the R axis represents the rotational speed Nr of the ring gear 32 obtained by dividing the rotational speed Nm2 of the motor MG2 by the gear ratio Gr of the reduction gear 35. Equation (1) is readily derived by using this alignment chart. The two thick arrows on the axis R respectively indicate torque applied to the ring gear shaft 32a due to the torque Tm1, output from the motor MG1, and torque applied to the ring gear shaft 32a via the reduction gear 35 due to the torque Tm2 output from the motor MG2. Equation (2) is a relational expression of a feedback control for rotating the motor MG1 at the target rotational speed Nm1*. In Equation (2), “k1” in the second team on the right side and “k2” in the third term on the right side respectively denote a gain of the proportional term and a gain of the integral term.

Nm1*=Ne*·(1+ρ)/ρ−Nm2/(Gr·ρ) (1)

Tm1*=−ρTe*/(1+ρ)+k1(Nm1*−Nm1)+k2∫(Nm1*−Nm1)dt (2)

Then, a provisional torque Tm2tmp, which is a provisional value of torque to be output from the motor MG2, is calculated using Equation (3) below by adding the value obtained from the division of the set torque command Tm1* by the gear ratio ρ of the power distribution/integration mechanism 30, to the requested torque Tr*, and further dividing the resulting sum by the gear ratio Gr of the reduction gear 35 (step S210). Torque limits Tm2min, and Tm2max, which are the upper and lower limit torques that may be output from the motor MG2, are calculated using Equation (4) and Equation (5) below by finding a difference between each of the input and output limits Win and Wout for the battery 50, and electric power consumed (electric power generated) by the motor MG1, which is obtained by multiplying the set torque command Tm1* by the current rotational speed Nm1 of the motor MG1, and dividing the difference by the rotational speed Nm2 of the motor MG2 (step S220). A torque command Tm2* for the motor MG2 is set by Equation (6) by limiting the set provisional motor torque Tm2tmp by the torque limits Tm2min and Tm2max (step S230). Equation (3) may be readily derived from the alignment chart of FIG. 7.

Tm2tmp=(Tr*+Tm1*/ρ)/Gr (3)

Tm2min=(Win−Tm1*·Nm1)/Nm2 (4)

Tm2max=(Wout−Tm1*·Nm1)/Nm2 (5)

Tm2*=max(min(Tm2tmp, Tm2max), Tm2min) (6)

After thus setting the target rotational speed Ne* and the target torque Te* for the engine 22, and the torque commands Tm1* and Tm2* for the motors MG1 and MG2, the target rotational speed Ne* and the target torque Te* for the engine 22 are transmitted to the engine ECU 24, and the torque commands Tm1* and Tm2* for the motors MG1 and MG2 are transmitted to the motor ECU 40 (step S240), and the drive control routine ends. Upon receiving the target rotational speed Ne* and the target torque Te* for the engine 22, the engine ECU 24 executes controls such as intake air flow control, fuel injection control, and ignition control for the engine 22 so that the engine 22 is driven at an operation point defined by the target rotational speed Ne* and the target torque Te*. Likewise, upon receiving the torque commands Tm1* and Tm2*, the motor ECU 40 controls the switching of the switching elements of the inverters 41 and 42 so that the motor MG1 is driven at the torque command Tm1* and the motor MG2 is driven at the torque command Tm2*. Through the control described above, when in the engine operation mode, the vehicle moves while controlling the state of charge SOC of the battery 50 based on the control central value SOC* and also efficiently operating the engine 22 within the range of the input and output limits Win and Wout for the battery 50 to output the requested torque Tr* to the ring gear shaft 32a.

On the other hand, if the requested power Pe* is below the first power threshold Pref and the state of charge SOC of the battery 50 exceeds the threshold Sref in steps S150 and S160, the motor operation mode is selected, in which a value 0 is set as the target rotational speed Ne* and as the target torque Te* for the engine 22 so that the engine 22 is stopped (step S190), and a value 0 is set to the torque command Tm1* for the motor MG1 (step S200). The torque command Tm2* is set based on the requested torque Tr* and the input and output limits Win and Wout for the battery 50 (steps S210 to S230), the target rotational speed Ne* and the target torque Te* for the engine 22, and the torque commands Tm*1 and Tm2* for the motors MG1 and MG2 are transmitted to the engine ECU 24 and the motor ECU 40, respectively (step S240), and the drive control routine ends. Accordingly, during the motor operation mode, the vehicle moves while outputting the requested torque Tr* to the ring gear shaft 32a within the range of the input and output limits Win and Wout for the battery 50.

Next, the control central value setting process shown in FIG. 4 will be described. The control central value setting process shown in FIG. 4 first sets an accelerator change rate ΔAcc and a brake change rate ΔBP, which are respectively the rate of change in the accelerator opening Acc and the rate of change in the brake pedal position BP within a predetermined period of time (for example, on the order of several minutes to several tens of minutes) in the past (step S300). In the embodiment the average value of the amounts of change in accelerator opening when the accelerator opening Acc is greater than the previous accelerator opening (previous Acc), that is, when the accelerator pedal 83 is progressively depressed (Acc−previous Acc), within the predetermined period of time in the past may be set as the accelerator change rate ΔAcc. Likewise, in the embodiment, the average value of the amount of change in brake pedal position, when the brake pedal position BP is larger than the previous brake pedal position (previous BP), that is, when the brake pedal 85 is progressively depressed (BP−previous BP), within the predetermined period of time in the past may be set as the brake change rate ΔBP.

After setting the accelerator change rate ΔAcc and the brake change rate ΔBP, the set accelerator change rate ΔAcc is divided by the brake change rate ΔBP to calculate an accelerator/brake change rate ratio Ptab (step S310). The value of the accelerator/brake change rate ratio Ptab increases as the accelerator change rate ΔAcc increases, that is, as the driver depresses the accelerator pedal 83 faster when accelerating the vehicle, or as the brake change rate ΔBP decreases, that is, as the driver depresses the brake pedal 85 slower when decelerating the vehicle.

Subsequently, the control central value SOC* is set based on the calculated accelerator/brake change rate ratio Ptab (step S320), and the control central value setting process ends. In this embodiment, the control central value SOC* is set by determining the relationship between the accelerator/brake change rate ratio Ptab and the control central value SOC* in advance and storing the relationship as a control central value setting map in the ROM 74, and deriving the corresponding control central value SOC* from the stored map when the accelerator/brake change rate ratio Ptab is given. An example of the control central value setting map is shown in FIG. 8. It should be noted that in FIG. 8, the upper and lower limit values Shi and Slow of the state-of-charge control range have been described above. As shown in the drawing, the control central value SOC* is set to increase as the accelerator/brake change rate ratio Ptab increases. Accordingly, the value set for the control central value SOC* increases when the driver requests faster acceleration or when the driver requests slower deceleration. By setting the control central value SOC* for the battery 50 in this way, the accelerator change rate ΔAcc and the brake change rate ΔBP are taken into account to set a more appropriate value as the control central value SOC*, and the state of charge of the battery 50 is controlled in a more appropriate manner.

In the hybrid automobile 20, the response of the engine 22 is slow relative to the motors MG1 and MG2. Thus, during acceleration, the power required to supplement a shortage of power is output from the motor MG2 by using electric power generated by the motor MG1 and discharged from the battery 50. Accordingly, if the accelerator/brake change rate ratio Ptab is relatively large (when the driver requests fast acceleration or slow deceleration with relatively high frequency), a relatively large control central value SOC* is set so that the amount of electric power discharged from the battery 50 is increased, thereby making it possible to meet the driver's acceleration request in a more satisfactory manner. Also, if the accelerator/brake change rate ratio Ptab is relatively small (when the driver requests slow acceleration with relatively high frequency), a relatively small control central value SOC* is set so that, during braking, the motor MG2 may be driven to perform regenerative braking to generate an increased amount of electric power for recharging the battery 50, thereby improving energy efficiency. It should be noted that when the accelerator/brake change rate ratio Ptab is relatively large, the motor operation mode may be continued over a longer period of time if the requested power Pe* is below the threshold Pref.

According to the hybrid automobile 20 of the embodiment described above, the accelerator/brake change rate ratio Ptab is calculated by dividing the accelerator change rate ΔAcc by the brake change rate ΔBP, the control central value SOC* for the battery 50 is set to increase as the calculated accelerator/brake change rate ratio Ptab increases. Thus, the requested charge/discharge power Pb* is set based on the set control central value SOC*, and the engine 22 and the motors MG1 and MG2 are controlled in accordance with the charge/discharge request power Pb*. Therefore, the control central value SOC* may be set in a more appropriate manner based on the accelerator change rate ΔAcc and the brake change rate ΔBP to thereby control the state of charge SOC of the battery 50. Also, it is understood that the vehicle may be moved by outputting a torque based on the requested torque Tr* to the ring gear shaft 32a serving as a drive shaft.

In the hybrid automobile 20 according to the embodiment, the control central value SOC* for the battery 50 is set based on the accelerator/brake change rate ratio Ptab, which is obtained by dividing the accelerator change rate ΔAcc by the brake change rate ΔBP. However, any configuration may be adopted as long as the control central value SOC* for the battery 50 is set based on the accelerator change rate ΔAcc and the brake change rate ΔBP.

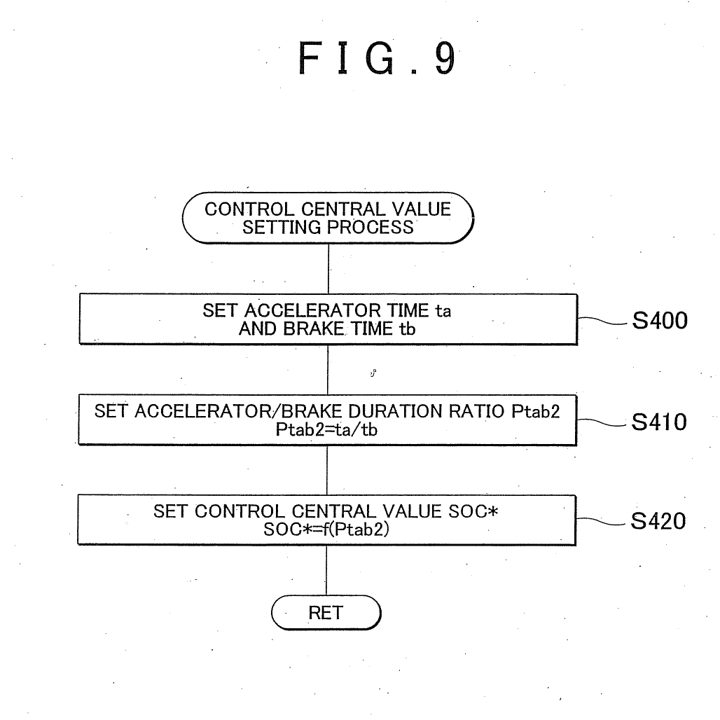

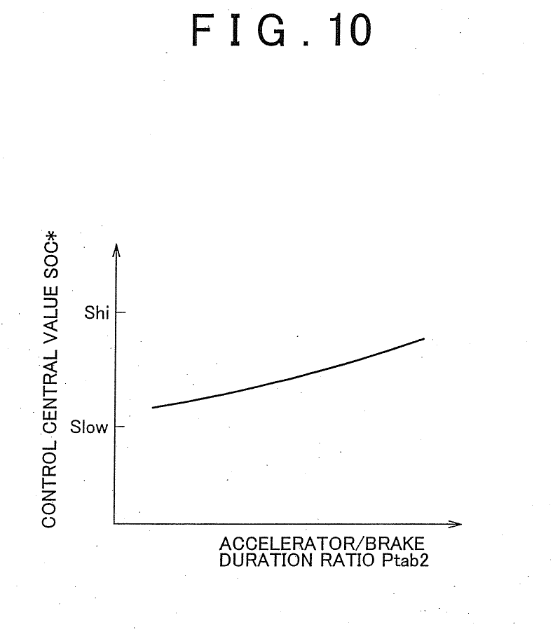

In the hybrid automobile 20 according to the embodiment, the control central value SOC* for the battery 50 is set based on the accelerator change rate ΔAcc and the brake change rate ΔBP. However, alternative to or in addition to ΔAcc and ΔBP, the control central value SOC* for the battery 50 may also be set based on an accelerator operation time ta, which is a period of accelerator-ON time within a predetermined period of time (for example, on the order of several minutes to several tens of minutes) in the past, and a brake operation time tb, which is a period of brake-ON time within the predetermined period of time. FIG. 9 shows an example of the control central value setting process when the control central value SOC* for the battery 50 is set based on the accelerator operation time ta and the brake operation time tb instead of the accelerator change rate ΔAcc and the brake change rate ΔBP. In the control central value setting process shown in FIG. 9, the accelerator operation time ta and the brake operation time tb are set based on the accelerator opening Acc and the brake pedal position BP (step S400), and the set accelerator operation time ta is divided by the brake operation time tb to calculate an accelerator/brake duration ratio Ptab2 (step S410). The control central value SOC* for the battery 50 is set based on the calculated accelerator/brake duration ratio Ptab2 (step S420), and the control central value setting process ends. In this modification, the control central value SOC* is set by using the relationship between the accelerator/brake duration ratio Ptab2 and the control central value SOC* as illustrated in FIG. 10. In the example of FIG. 10, the control central value SOC* is set to increase as the accelerator/brake duration ratio Ptab2 increases. By setting the control central value SOC* in this way, if the accelerator/brake duration ratio Ptab2 is relatively large, a relatively large control central value SOC* is set so that the amount of electric power that can be discharged from the battery 50 becomes larger, thereby making it possible to meet the driver's acceleration request in a more satisfactory manner. Also, if the accelerator/brake duration ratio Ptab2 is relatively small, a relatively small control central value SOC* is set so that, during braking, the motor MG2 is driven to perform regenerative braking to generate a larger amount of electric power for recharging the battery 50, thereby improving energy efficiency. It should be noted that when the accelerator/brake duration ratio Ptab2 is relatively large, the motor operation mode may be maintained over a longer period of time if the requested power Pe* is below the first power threshold Pref.

In this modification, the control central value SOC* for the battery 50 is set based on the accelerator/brake duration ratio Ptab2 that is obtained by dividing the accelerator operation time ta by the brake operation time tb. However, any configuration may be adopted as long as the control central value SOC* for the battery 50 is set based on the accelerator operation time ta and the brake operation time tb. For example, the control central value SOC* for the battery 50 may be set based on a value obtained by dividing the accelerator operation time ta by the sum of the accelerator operation time ta and the brake operation time tb (ta/(ta+tb)). Also, while the description of this modification is directed to a case where the control central value SOC* for the battery 50 is set based on the accelerator operation time ta and the brake operation time tb instead of the accelerator change rate ΔAcc and the brake change rate ΔBP, if the control central value SOC* for the battery 50 is set based on the accelerator change rate ΔAcc and the brake change rate ΔBP, and the accelerator operation time ta and the brake operation time tb, the control central value SOC* for the battery 50 may be set to increase as the accelerator/brake change rate Ptab(=ΔAcc/ΔBP) increases and as the accelerator/brake operation time ratio Ptab2(=ta/tb) increases.

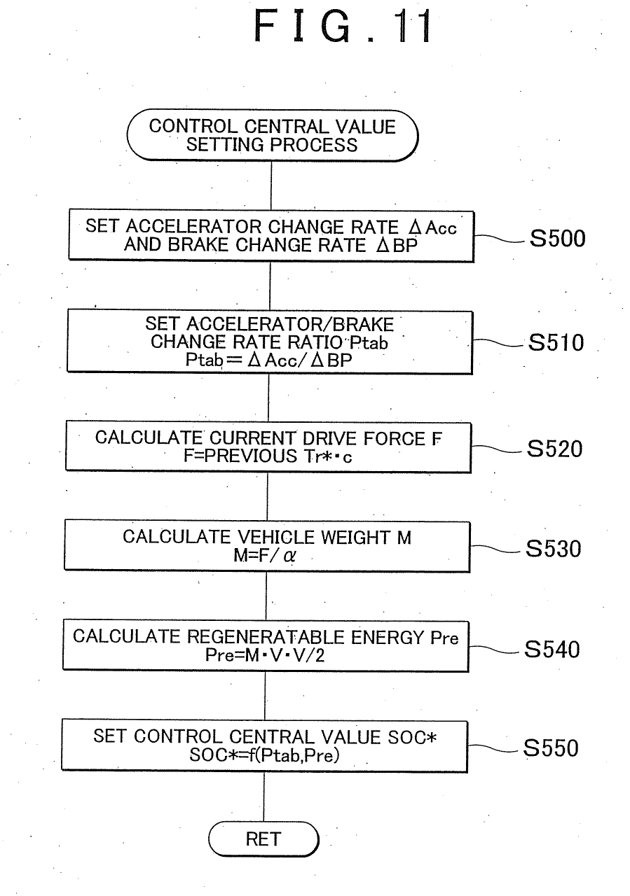

In the hybrid automobile 20, the control central value SOC* for the battery 50 is set based on the accelerator change rate ΔAcc and the brake change rate ΔBP. However, the vehicle weight M or the vehicle speed V may also be taken into account in setting the control central value SOC* for the battery 50. An example of the control central value setting process in this case is shown in FIG. 11. In the control central value setting process shown in FIG. 11, first, similar to steps S300 and S310 of the control central value setting process shown in FIG. 4, the accelerator change rate ΔAcc and the brake change rate ΔBP are set to calculate the accelerator/brake change rate ratio Ptab (steps S500. and S510). Subsequently, the requested torque (previous Tr*) set in the previous execution of the drive control routine of FIG. 2 is multiplied by a conversion factor c (factor for converting the torque applied to the ring gear shaft 32a into the current drive force F) to calculate the current drive force F, which is the current motive drive force (step S520), and the calculated current drive force F is divided by an acceleration a input from an acceleration sensor (not shown) to calculate the vehicle weight M (step S530). By calculating the vehicle weight M in this way, it is possible to calculate the vehicle weight M that more appropriately reflects the weight of the occupants, the amount of fuel, and the like. Then, by using the vehicle weight M and the vehicle speed V thus calculated, regeneratable energy Pre that can be regenerated, during braking, by driving the motor MG2 to perform regenerative braking is calculated by Equation (7) below (step S540), and the control central value SOC* for the battery 50 is set based on the accelerator/brake change rate ratio Ptab and the regeneratable energy Pre (step S550); and the control central value setting process ends.

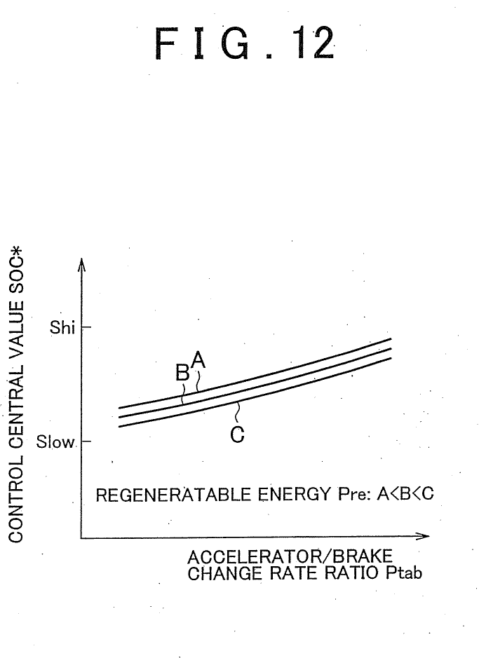

In this modification, the control central value SOC* is set by using the relationship among the accelerator/brake change rate ratio Ptab, the regeneratable energy Pre, and the control central value SOC* as illustrated in FIG. 12. In the example of FIG. 12, the control central value SOC* is set to increase as the accelerator/brake change rate ratio Ptab increases. The effect attained by setting the control central value SOC* in this way has been described above. Also, the control central value SOC* is set so as to decrease as the regeneratable energy Pre increases. Accordingly, at braking, the motor MG2 can be driven to perform regenerative braking to generate a larger amount of electric power for recharging the battery 50, thereby improving energy efficiency. In this modification, the control central value SOC* for the battery 50 is set based on the accelerator/brake change rate ratio Ptab, and the regeneratable energy Pre based on the vehicle weight M and the vehicle speed V. However, the control central value SOC* for the battery 50 may be set directly based on the accelerator/brake change rate ratio Ptab, and the vehicle weight M and the vehicle speed V, without calculating the regeneratable energy Pre. In this case, the control central value SOC* for the battery 50 may be set to increase as the accelerator/brake change rate ratio Ptab increases, to decrease as the vehicle weight M increases, and to decreases as the vehicle speed V increases. Also, the control central value SOC* for the battery 50 may be set by using the accelerator/brake operation time ratio Ptab2 instead of or in addition to the accelerator/brake change rate ratio Ptab, that is, based on the accelerator brake operation time ratio Ptab2, and the vehicle weight M and the vehicle speed V.

Pre=M·V²/2 (7)

In the hybrid automobile 20 according to the embodiment, the control central value SOC* for the battery 50 is set based on the accelerator change rate ΔAcc and the brake change rate ΔBP. However, the control central value SOC* for the battery 50 may be set based on an accelerator integrated value Iacc, which is an integrated value of accelerator openings Acc during the accelerator-ON duration within a predetermined period of time in the past, and a brake integrated value Ibp that is an integrated value of brake pedal positions BP during the brake-ON operation duration within the predetermined period of time. In this case, the control central value SOC* for the battery 50 may be set to increase as the value obtained by dividing the accelerator integrated value Iacc by the brake integrated value Ibp (Icc/Ibp) increases.

In the hybrid automobile 20 according to the embodiment, the control central value SOC* for the battery 50 is set based on the accelerator change rate ΔAcc and the brake change rate ΔBP. However, the control central value SOC* for the battery 50 may be set based on the requested torque Tr* based on the accelerator opening Acc and the brake pedal position BP. In this case, for example, based on the requested torque Tr* in a predetermined period of time in the past, the control central value SOC* for the battery 50 may be set to increase as the period of time during which the requested torque Tr* is positive becomes longer relative to the period of time during which the requested torque Tr* is negative. Alternatively, the control central value SOC* for the battery 50 may be set to increase as the amount of change per unit time in the requested torque Tr* in the positive direction when the requested torque Tr* is positive increases relative to the amount of change per unit time in the requested torque Tr* in the negative direction when the requested torque Tr* is negative.

In the hybrid automobile 20 according to the embodiment, the control central value SOC* for the battery 50 is set based on the accelerator change rate ΔAcc and the brake change rate ΔBP. However, the control central value SOC* for the battery 50 may be set based on the torque command Tm2* for the motor MG2, which is set using the requested torque Tr* based on the accelerator opening Acc and the brake pedal position BP. In this case, for example, based on the torque command Tm2* for the motor MG2 over a predetermined period of time in the past, a powering time tpo, which represents the period of time over which the motor MG2 is powering driven, and a regeneration time tre, which represents the a period of time over which the motor MG2 is driven to perform regenerative braking, are set, and the control central value SOC* for the battery 50 may be set to increase as the set powering time tpo increases relative to the regeneration time tre. Alternatively, the control central value SOC* for the battery 50 may be set to increase as the power output from the motor MG2 upon powering drive of the motor MG2 increases relative to the electric power generated by the motor MG2 when the motor MG2 is driven to perform regenerative braking.

In the hybrid automobile 20 according to the embodiment, the control central value SOC* for the battery 50 is set based on an accelerator operation or brake operation over a predetermined period of time in the past. However, as long as the information used is that of a prior accelerator operation or brake operation, the information is not limited to such an operation made over a predetermined period of time but may be, for example, information of accelerator operation or brake operation made before the previous ignition-Off operation.

In the hybrid automobile 20 according to the embodiment, the control central value SOC* for the battery 50 is set based on both an accelerator operation and a brake operation in a predetermined period of time in the past. However, as long as the accelerator operation is used to set the control central value SOC*, it is not necessary to use both the accelerator operation and the brake operation. For example, the control central value SOC* for the battery 50 may be set solely based on the accelerator operation. In this case, for example, the SOC* for the battery 50 may be set so as to increase as the accelerator change rate ΔAcc increases. In this way, as in the embodiment, when the driver requests fast acceleration with relatively high frequency, the request for fast acceleration may be met in a more satisfactory manner, and when the driver instead requests slow acceleration with relatively high frequency, during braking, the motor MG2 may be driven to perform regenerative braking to generate more electric power for recharging the battery 50, thereby improving energy efficiency.

In the hybrid automobile 20 according to the embodiment, the motor MG2 is attached to the ring gear shaft 32a via the reduction gear 35. However, the motor MG2 may be directly attached to the ring gear shaft 32a, or the motor MG2 may be attached to the ring gear shaft 32a via a transmission such as a two-speed, three-speed, or four-speed transmission instead of the reduction gear 35.

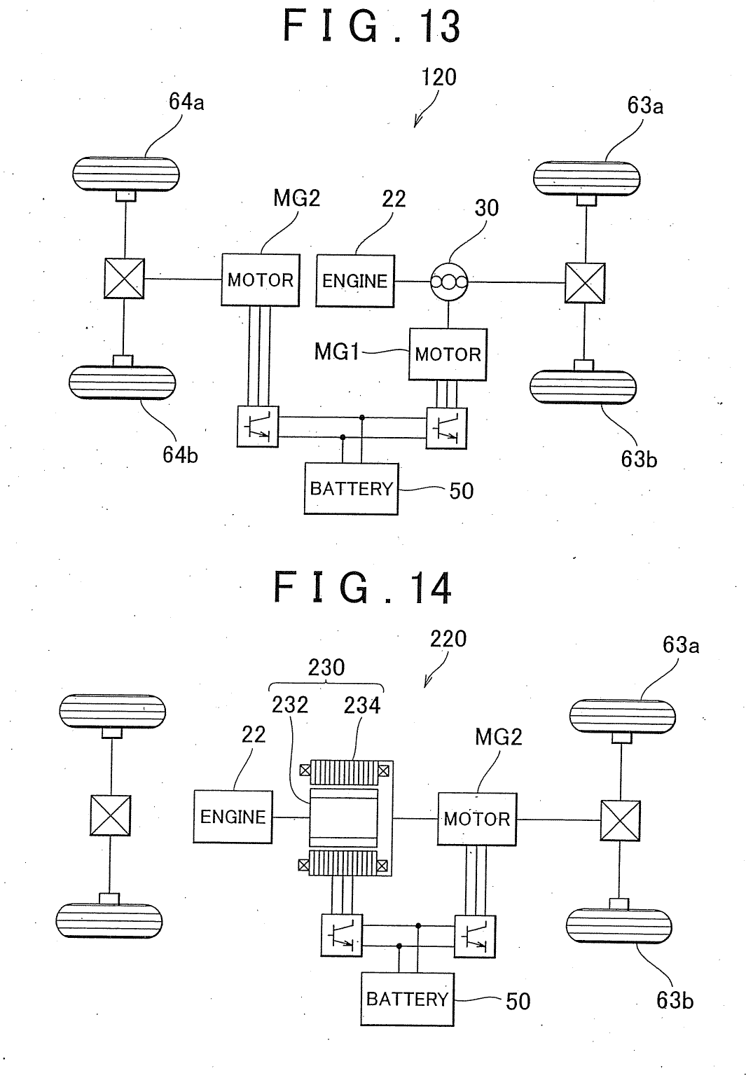

In the hybrid automobile 20 according to the embodiment, the power of the motor. MG2 is output to the ring gear shaft 32a after speed change by the reduction gear 35. However, as illustrated by the hybrid automobile 120 shown in FIG. 13, the power of the motor MG2 may be connected to an axle (the axle connected to wheels 64a, 64b in FIG. 13) other than the axle to which the ring gear shaft 32a is connected (the axle to which the drive wheels 63a and 63b are connected).

In the hybrid automobile 20 according to the embodiment, the power of the engine 22 is output to the ring gear 32a, which is connected to the drive wheels 63a and 63b via the power distribution/integration mechanism 30. However, as illustrated by a hybrid automobile 220 shown in FIG. 14, a paired rotor electric motor 230 may be provided. The paired rotor electric motor 230 includes an inner rotor 232 that is connected to the crankshaft 26 of the engine 22 and an outer rotor 234 connected to the drive shaft that outputs power to the drive wheels 63a and 63b, and transmits part of the power from the engine 22 to the drive shaft while converting the remaining power into electric power.

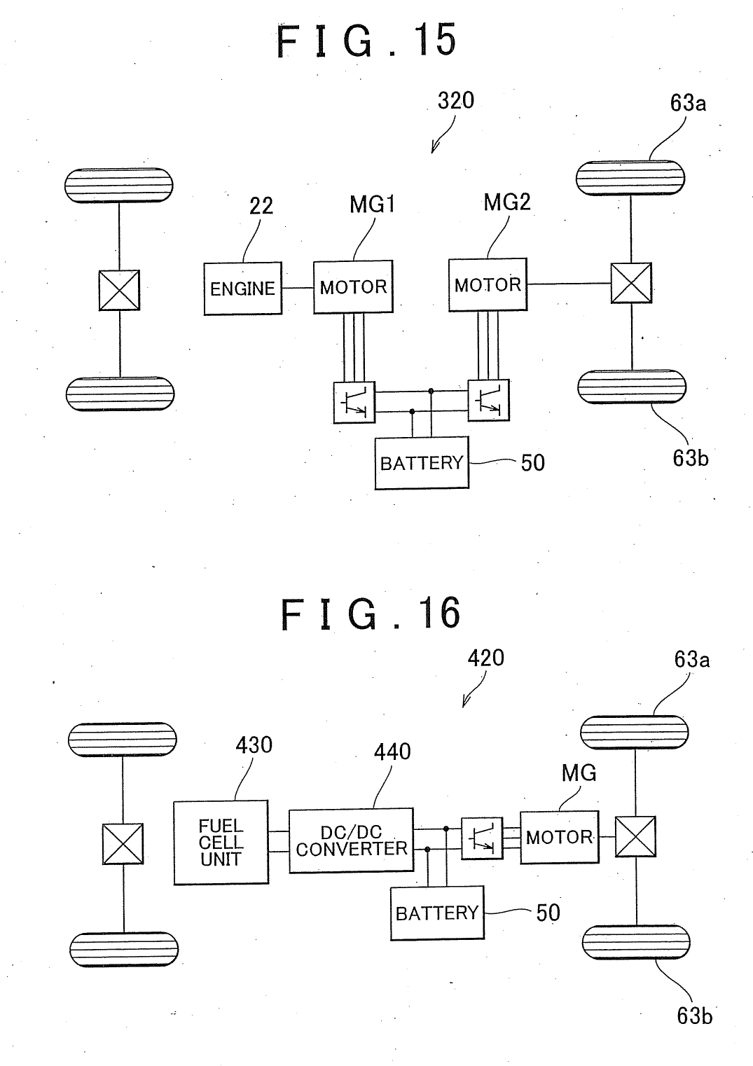

In the hybrid automobile 20 according to the embodiment, the power of the engine 22 is output to the ring gear 32a, which is connected to the drive wheels 63a and 63b via the power distribution/integration mechanism 30. However, as illustrated by a hybrid automobile 320 shown in FIG. 15, the motor MG1 for power generation may be attached to the engine 22, and the motor MG2 for vehicle motion may be provided.

The present invention is not limited to a hybrid automobile, but, as illustrated by the fuel cell powered automobile 420 shown in FIG. 16, the voltage of the electric power generated by the fuel cell 430 may be boosted by a DC/DC converter 440 before being supplied to the battery 50 or the motor MG.

The present invention is not limited to an automobile but may be a vehicle other than an automobile, such as a train. Further, the present invention may concern a method of controlling such a vehicle.

The engine 22, the motor MG1, and the power distribution/integration mechanism 30 in the embodiment may be regarded as “electric power generating means” according to the present invention. The motor MG2, the battery 50, and the vehicle speed sensor 88 in the embodiment may be regarded as the “electric motor”, “charge storage means”, and “vehicle speed detecting means” according to the present invention, respectively. Further, in the embodiment, the hybrid electronic control unit 70 executing the process of step S110 of the drive control routine in FIG. 2, which sets the requested torque Tr* based on the accelerator opening Acc, the brake pedal position BP, and the vehicle speed V, may be regarded as the “requested drive force setting means” according to the present invention. In the embodiment, the hybrid electronic control unit 70 executing the control central value setting process in FIG. 4, which sets the control central value SOC* for the battery 50 based on the accelerator change rate ΔAcc, which represents the rate of change in the accelerator opening Acc in a predetermined period of time in the past, and the brake change rate ΔBP, which represents the rate of change in the brake pedal position BP in the predetermined period of time, may be regarded as the “control central value setting means” according to the present invention. In the embodiment, the hybrid electronic control unit 70 that executes the process of steps S130 to S240 of the drive control routine in FIG. 2, the engine ECU 24 that receives the target rotational speed Ne* and the target torque Te* from the hybrid electronic control unit 70 and controls the engine 22, and the motor ECU 40 that receives the torque commands Tm1* and Tm2* from the hybrid electronic control unit 70 and controls the motors MG1 and MG2, may be regarded as the “control means” according to the present invention. Note that, as already described above, the process of steps S130 to S240 sets the target rotational speed Ne* and the target torque Te* for the engine 22 and the torque commands Tm1* and Tm2* for the motors MG1 and MG2 in such a way that the state of charge SOC of the battery 50 is controlled based on the control central value SOC* and the requested torque Tr* is output to the ring gear shaft 32a within the range of the input and output limits Win and Wout for the battery 50, and transmits the set values to the engine ECU 24 and the motor ECU 40. Further, the engine 22 and the power distribution/integration mechanism 30 in the embodiment may be respectively regarded as the “internal combustion engine” and “triaxial power transfer means” in the claims of the present invention. The motor MG1 and the paired rotor electric motor 230 may be also regarded as “generator” according to the present invention. Further, the fuel cell 430 in the embodiment may be also regarded as “electric power generating means” in the claims of the present invention.

The “electric power generating means” according to the present invention is not limited to the combination of the engine 22, the motor MG1, and the power distribution/integration mechanism 30, or the fuel cell 430, but may be any configuration that can generate electric power upon receiving supply of fuel. The “electric motor” according to the present invention is not limited to the motor MG2 in the embodiment that is a synchronous generator/motor, but may be any configuration that can output a motive drive force, such as an induction electric motor. The “charge storage means” according to the present invention is not limited to the battery 50 in the embodiment which is a lithium ion battery, but may be any configuration that can exchange electric power with the electric power generating means and the electric motor, such as a nickel hydrogen battery or a lead battery. The “requested drive force setting means” according to the present invention is not limited to the configuration in the embodiment that sets the requested torque Tr* based on the accelerator opening Acc, the brake pedal position BP, and the vehicle speed V, but may be any configuration that sets a requested drive force to move the vehicle, such as one that sets a requested torque based on the accelerator opening Acc and the brake pedal position BP without taking the vehicle speed V into account.

The “control central value setting means” according to the present invention is not limited to a configuration that sets the control central value SOC* for the battery 50 based on the accelerator change rate ΔAcc, which represents the rate of change in the accelerator opening Acc in a predetermined period of time in the past and the brake change rate ΔBP, which represents the rate of change in the brake pedal position BP in the predetermined period of time. Instead, the “control central value setting means”may be any configuration that sets the central value of the state-of-charge control range used for controlling the state of charge of the charge storage means based on at least an accelerator operation in the past, including: setting the control central value SOC* for the battery 50 based on the accelerator operation time ta, which represents the period of accelerator-ON time within a predetermined period of time in the past and the brake operation time tb, which represents the period of brake-ON time within the predetermined period of time; setting the control central value SOC* for the battery 50 based on the accelerator change rate ΔAcc, the brake change rate ΔBP, the accelerator operation time ta, and the brake operation time tb; setting the control central value SOC* for the battery 50 based on the accelerator change rate ΔAcc, the brake change rate ΔBP, the vehicle weight M, and the vehicle speed V; setting the control central value SOC* for the battery 50 based on the accelerator operation time ta, the brake operation time tb, the vehicle weight M, and the vehicle speed V; setting the control central value SOC* for the battery 50 the accelerator integrated value Iacc, which is an integrated value of accelerator openings Acc during the accelerator-ON time within a predetermined period of time in the past, and the brake integrated value Ibp, which is an integrated value of brake pedal positions BP during the brake-ON time within the predetermined period of time; setting the control central value SOC* for the battery 50 based on the value of the requested torque Tr*, which is set based on the accelerator opening Acc and the brake pedal position BP, in a predetermined period of time in the past; setting the control central value SOC* for the battery 50 based on the value of the torque command Tm2* for the motor MG2, which is set using the requested torque Tr* based on the accelerator opening Acc and the brake pedal position BP, in a predetermined period of time in the past; and setting the control central value SOC* for the battery 50 solely based on an accelerator operation in the past without taking a brake operation in the past into account.

The “control means” according to the present invention is not limited to the combination of the hybrid electronic control unit 70, the engine ECU 24, and the motor ECU 40, but may be a single electronic control unit. Also, the “control means” according to the present invention is not limited to a configuration that controls the engine 22 and the motors MG1 and MG2 by setting the target rotational speed Ne* and the target torque Te* for the engine 22 and the torque commands Tm1* and Tm2* for the motors MG1 and MG2 in such a way that the state of charge SOC of the battery 50 is controlled based on the control central value SOC* and the requested torque Tr* is output to the ring gear shaft 32a within the range of the input and output limits Win and Wout of the battery 50. The “control means” may be any configuration that controls the electric power generating means and the electric motor so that the state of charge of the charge storage means is controlled based on the set central value and that the vehicle moves by the drive force based on the requested drive force.

The “internal combustion engine” according to the present invention is not limited to an internal combustion engine that outputs power using a hydrocarbon fuel, such as gasoline or diesel oil, but may be an internal combustion engine of any type such as a hydrogen fueled engine. In addition, the “generator” according to the present invention is not limited to the motor MG1, which is a synchronous generator/motor, or the paired rotor electric motor 230, but may be any configuration that can generate electric power by using at least some of the power from the internal combustion engine, such as, for example, an induction electric motor. The “triacial power transfer means” according to the present invention is not limited to the power distribution/integration mechanism 30 described above, but may be any configuration that is connected to three shafts, including the drive shaft, the output shaft of the internal combustion engine, and the rotating shaft of the generator, and that, based on the power input/output to one of the three shafts, inputs/outputs power to the remaining shafts, such as a double-pinion planetary gear mechanism, a combination of a plurality of planetary gear mechanisms connected to four or more shafts, or one having an operation/action different from a planetary gear such as a differential gear.

It should be understood that the description of the correspondence between the major elements in the embodiment and the major elements according to the present invention is given by way of a specific example for carrying out the present invention, and is not intended to restrict the elements according to the present invention to the elements in the embodiment.

While some embodiments of the invention have been illustrated above, it is to be understood that the invention is not limited to details of the described embodiments, but may be embodied with various changes, modifications or improvements, which may occur to those skilled in the art, without departing from the scope of the invention.

1. (canceled)

2. The vehicle according to claim 14, wherein the control central value setting section sets the central value based on a brake operation, in addition to the accelerator operation.

3. The vehicle according to claim 2, wherein the control central value setting section sets the central value based on an accelerator change rate, which is an amount of change in accelerator operation per unit time in a predetermined period of time, and a brake change rate, which is an amount of change in brake operation per unit time in the predetermined period of time.

4. The vehicle according to claim 3, wherein the accelerator change rate is the amount of change in accelerator operation per unit time when the amount of accelerator operation increases in the predetermined period of time, and the brake change rate is the amount of change in brake operation per unit time when the amount of brake operation increases in the predetermined period of time.

5. The vehicle according to claim 4, wherein the control central value setting section increases the central value as the accelerator change rate increases relative to the brake change rate.

6. The vehicle according to claim 2, wherein the control central value setting section sets the central value based on an accelerator operation time, which is a duration of time over which the accelerator is operated within a predetermined period of time, and a brake operation time, which is a duration of time over which the brake is operated within the predetermined period of time.

7. The vehicle according to claim 6, wherein the control central value setting section increases the central value as the accelerator operation time increases relative to the brake operation time.

8. The vehicle according to claim 14, wherein the control central value setting section computes a vehicle weight based on a motive drive force that is output to move the vehicle and an acceleration of the vehicle, and sets the central value based on the accelerator operation, the computed vehicle weight, and the vehicle speed.

9. The vehicle according to claim 14, wherein:
the requested drive force setting section sets the requested drive force based on the accelerator operation and a brake operation; and
the control central value setting section sets the central value based on the requested drive force.

10. The vehicle according to claim 14, wherein:
the requested drive force setting section sets the requested drive force based on the accelerator operation and a brake operation;
the control section sets a target drive state of the electric motor based on the set requested drive force and also controls the electric motor so that the electric motor is driven in the set target drive state; and
the control central value setting section sets the central value based on the drive state of the electric motor.

11. The vehicle according to claim 14, wherein the electric power generating section includes an internal combustion engine, and a generator that generates electric power by using at least a part of power from the internal combustion engine.

12. The vehicle according to claim 11, wherein:
the electric power generating section includes a triaxial power transfer section connected to a drive shaft, which is coupled to an axle; an output shaft of the internal combustion engine; and a rotating shaft of the generator; for transferring power, based on power input from two of the three shafts, to the remaining shaft, and for transferring power based on power input from one of the three shafts, to the remaining two shafts; and
the electric motor input power from or outputs power to the drive shaft.

13. A method of controlling a vehicle that includes an electric power generating section that generates electric power when supplied with fuel, an electric motor that outputs motive power, and a charge storage section that exchanges electric power with the electric power generating section and the electric motor, comprising:
setting a central value of a state-of charge in a range of state-of-charge control used to control a state of charge of the charge storage section, based on an accelerator operation;
controlling a state of charge of the charge storage section based on the set central value; and
controlling the electric power generating section and the electric motor so that the vehicle moves by a requested drive force to move the vehicle.

14. A vehicle comprising:
an electric power generating section that generates electric power when supplied with fuel;
an electric motor that outputs motive power;
a charge storage section that exchanges electric power with the electric power generating section and the electric motor;
a requested drive force setting section that sets a requested drive force to move the vehicle;
a central value setting section that sets a central value of a range of state-of-charge control used to control a state of charge of the charge storage section, based on an accelerator operation; and
a control section that controls a state of charge of the charge storage section based on the set central value, and controls the electric power generating section and the electric motor so that the vehicle moves by the set requested drive force.
